(19) United States
(12) Patent Application Publication
(10) Pub. No.: US 2011/0200238 A1
(43) Pub. Date: Aug. 18, 2011

(54) METHOD AND SYSTEM FOR DETERMINING SKINLINE IN DIGITAL MAMMOGRAM IMAGES

(75) Inventors: Hrushikesh Garud, Parbhani (IN); Ajoy Kumar Ray, Kharagpur (IN); Ashoka Gopalakrishna Kargallu, Bantwala Taluk (IN); Debdoot Sheet, Kharagpur (IN)

(73) Assignee: Texas Instruments Incorporated, Dallas, TX (US)

(21) Appl. No.: 12/705,984

(22) Filed: Feb. 16, 2010

(51) Int. Cl. G06K 9/40; G06K 9/00

(52) U.S. Cl. 382/128

(57) ABSTRACT

Method and system for determining skinline in digital mammogram images. The method includes smoothening a digital mammogram image to yield a smoothened image. The method also includes determining gradient in the digital mammogram image to yield a gradient map. Further, the method includes extracting breast region from the digital mammogram image based on the smoothened image and the gradient map using fuzzy rule based pixel classification to yield a binary image. Moreover, the method includes filtering the binary image to remove noise and to yield a filtered image. The method also includes extracting boundary of the breast region in the filtered image. Furthermore, the method includes detecting the skinline based on the boundary of the breast region.

### TECHNICAL FIELD

Embodiments of the disclosure relate to the field of breast skinline detection.

### BACKGROUND

Breast cancer is a type of malignancy occurring in both men and women. Existing diagnostic imaging techniques for breast lesion detection and diagnosis include, but are not limited to ultrasound imaging, magnetic resonance imaging, computerized tomography scan, and x-ray mammography. Often, x-ray mammography is used in screening of a breast for early stage detection and diagnosis of breast lesions. Examples of x-ray mammography techniques include film based x-ray mammography, digital breast tomography and full field digital mammography.

It is noted while diagnosing the breast lesions that thickening of skin and skin retractions are indications of malignancy. It is also noted that micro-calcifications found on, or immediately below a breast skinline are considered benign. In one example, the breast skinline can be defined as a demarcation line that separates a breast region from a background region. Accurate knowledge of breast skinline and position of abnormalities from the breast skinline is needed for diagnosing the breast lesions. Often, the position of the abnormalities is reported relative to the breast skinline. A mammography technician upon finding a suspicious lesion in one view must locate the suspicious lesion in another view at same distance from the breast skinline. Further, the mammography technician has to ensure that equal amounts of tissue, between the breast skinline and chest wall, are visualized in all views taken. The breast skinline and relative position of nipple acts as a registration aid and a marker for detecting and reporting the abnormalities in the breast region. In existing x-ray mammography techniques, visualization of the breast skinline is difficult and error prone. Also, detection of the breast skinline requires human intervention. In one example, inaccurate detection of the breast skinline can cause failure to diagnose the breast lesions. In another example, the inaccurate detection of the breast skinline can cause overlooking of certain cancerous regions of the breast.

### SUMMARY

An example of a method for determining skinline in a digital mammogram image includes smoothening the digital mammogram image to yield a smoothened image. The method includes determining gradient in the digital mammogram image to yield a gradient map. Further, the method includes extracting breast region from the digital mammogram image based on the smoothened image and the gradient map using fuzzy rule based pixel classification to yield a binary image. The method includes filtering the binary image to remove noise and to yield a filtered image. The method includes extracting boundary of the breast region in the filtered image. The method includes detecting the skinline based on the boundary of the breast region.

An example of a method for determining skinline in a digital mammogram image by an image processing unit includes smoothening the digital mammogram image to yield a smoothened image. The method includes determining gradient in the digital mammogram image to yield a gradient map. The method includes extracting breast region from the digital mammogram image based on the smoothened image and the gradient map using fuzzy rule based pixel classification to yield a binary image. The method includes filtering the binary image to remove noise and to yield a filtered image. The method includes extracting boundary of the breast region in the filtered image. The method includes filtering the digital mammogram image based on a homomorphic filtering technique to yield a homomorphic filtered image. The method also includes detecting the skinline based on the smoothened image, the gradient map, and the homomorphic filtered image.

An example of an image processing unit (IPU) for determining skinline in a digital mammogram image includes an image acquisition unit that electronically receives the digital mammogram image. The IPU includes a digital signal processor (DSP) responsive to the digital mammogram image to de-noise the digital mammogram image, smoothen the digital mammogram image to yield a smoothened image, determine gradient in the digital mammogram image to yield a gradient map, extract breast region from the digital mammogram image based on the smoothened image and the gradient map using fuzzy rule based pixel classification to yield a binary image, filter the binary image to remove noise and to yield a filtered image, extract boundary of the breast region in the filtered image, filter the digital mammogram image based on a homomorphic filtering technique to yield a homomorphic filtered image, and detect the skinline based on at least one of the smoothened image, the gradient map, and the homomorphic filtered image.

### BRIEF DESCRIPTION OF THE VIEWS OF DRAWINGS

In the accompanying figures, similar reference numerals may refer to identical or functionally similar elements. These reference numerals are used in the detailed description to illustrate various embodiments and to explain various aspects and advantages of the disclosure.

FIG. 1 illustrates an environment for determining skinline in a digital mammogram image, in accordance with one embodiment;

FIG. 2A illustrates a flow chart for determining skinline in a digital mammogram image, in accordance with one embodiment;

FIG. 2B illustrates a flow chart for determining skinline in a digital mammogram image, in accordance with another embodiment;

FIG. 2C illustrates a flowchart for image analysis for breast lesion detection and diagnosis based on skinline detection in a digital mammogram image, in accordance with one embodiment;

FIG. 3 illustrates a block diagram of a system for determining skinline in a digital mammogram image, in accordance with one embodiment;

FIG. 4 illustrates a block diagram for performing homomorphic filtering technique, in accordance with one embodiment;

FIG. 5 is an exemplary illustration of amplitude response of a homomorphic filter, in accordance with one embodiment;

FIG. 6A and FIG. 6B illustrate exemplary graphs used to analyze a rule base in fuzzy rule based pixel classification, in accordance with one embodiment;

FIG. 7A and FIG. 7B illustrates a morphological extraction technique, in accordance with one embodiment;

FIG. 8 is an exemplary illustration of a digital mammogram image, in accordance with one embodiment;

FIG. 9 is an exemplary illustration of a digital mammogram image, in accordance with another embodiment;

FIG. 10 is an exemplary illustration of a digital mammogram image after de-noising, in accordance with one embodiment;

FIG. 11 is an exemplary illustration of a smoothened image, in accordance with one embodiment;

FIG. 12 is an exemplary illustration of a gradient map, in accordance with one embodiment;

FIG. 13 is an exemplary illustration of a homomorphic filtered image, in accordance with one embodiment;

FIG. 14 is an exemplary illustration of a binary image after fuzzy rule based pixel classification, in accordance with one embodiment;

FIG. 15 is an exemplary illustration of a morphologically filtered image, in accordance with one embodiment;

FIG. 16 is an exemplary illustration of a digital mammogram image after boundary extraction, in accordance with one embodiment;

FIG. 17 is an exemplary illustration of a digital mammogram image after boundary extraction, in accordance with another embodiment;

FIG. 18 is an exemplary illustration of a digital mammogram image after skinline detection based on active contour technique, in accordance with one embodiment; and

FIG. 19 is an exemplary illustration of a digital mammogram image after skinline detection based on active contour technique, in accordance with another embodiment.

### DETAILED DESCRIPTION OF THE EMBODIMENTS

Various embodiments discussed in disclosure pertain to determining of breast skinline in a digital x-ray mammogram. The breast skinline, hereinafter referred to as the skinline can be defined as a demarcation line that separates a breast region from a background region. In one example, the background region includes a region outside body. Accurate determination of the skinline is required to detect and diagnose breast lesions.

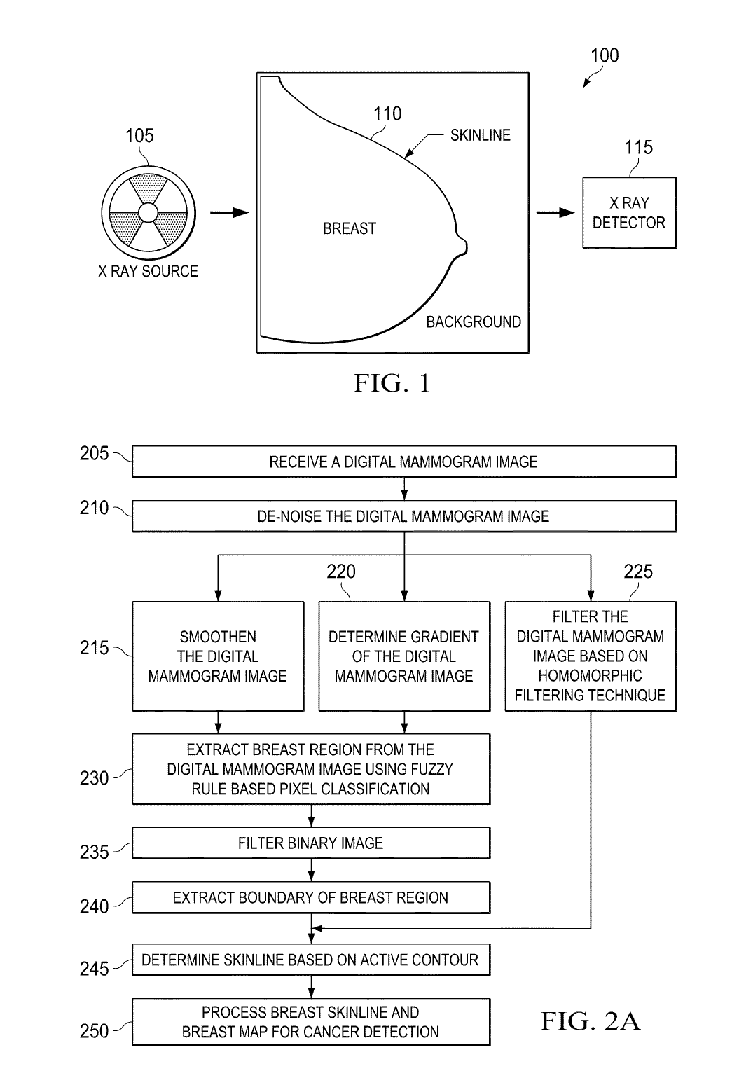

An environment 100 for determining the skinline is shown in FIG. 1. The environment 100 includes an x-ray source 105, an x-ray detector 115, and a breast 110 placed between the x-ray source 105 and the x-ray detector 115 for screening the breast 110. In one example, the x-ray source 105 can be a linear accelerator that generates x-rays by accelerating electrons. The x-ray detector 115 detects the x-rays and generates the digital mammogram image of the breast 110. Examples of the x-ray detector 115 include, but are not limited to photographic plate, a Geiger counter, a scintillator, and a semiconductor detector.

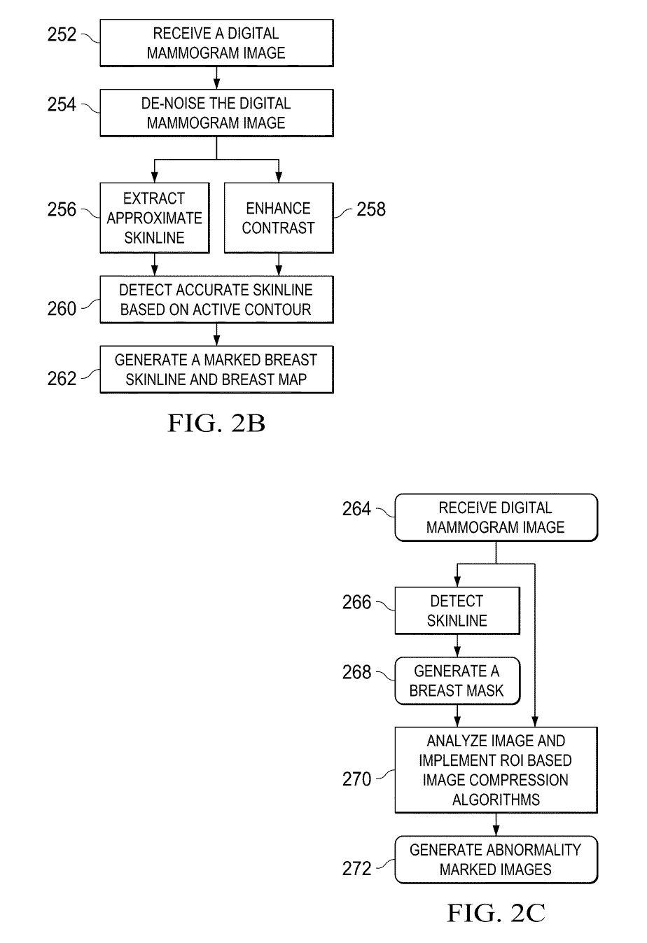

The determining of skinline is explained in conjunction with FIG. 2A and FIG. 2B.

Referring to FIG. 2A, various steps involved in determining skinline are illustrated.

At step 205, a digital mammogram image is received. The digital mammogram image can be received from an image source or an image detector, for example the x-ray detector 115. The digital mammogram image, hereinafter referred to as the image can be an uncompressed 8/10/12/14 bit grayscale image.

At step 210, the image is de-noised. De-noising the image includes removing speckle noise and salt-pepper noise from the image. The speckle noise can be defined as a granular noise that exists in the image as a result of random fluctuations in a return signal from an object whose magnitude is no larger than a pixel. The salt-pepper noise can be defined as randomly occurring white and black pixels in the image as a result of quick transients like faulty switching while capturing the image.

In some embodiments, the de-noising includes removing the speckle noise and the salt-pepper noise using a median filter.

The median filter can be referred to as non-linear digital filtering technique and can be used to prevent edge blurring. A median of neighboring pixels values can be calculated. The median can be calculated by repeating following steps for each pixel in the image.

a) Storing the neighboring pixels in an array. The neighboring pixels can be selected based on shape, for example a box or a cross. The array can be referred to as a window, and is odd sized.

b) Sorting the window in numerical order.

c) Selecting the median from the window as the pixels value.

In one example, the median filter can be a 3×3 median filter.

At step 215, the image is smoothened to yield a smoothened image. In one example, smoothening includes convoluting the image with a finite sized averaging mask, for example with an N×N averaging mask. The convolution can be defined as a mathematical operation that involves selection of a window of a finite size and shape, for example an N×N window and scanning the window across the image to output a pixel value that is a weighted sum of input pixels within the window. The window can be considered as a filter that filters the image to smoothen or sharpen the image. The smoothened image represents average gray level value of pixels surrounding the pixel.

At step 220, gradient in the image is determined to yield a gradient map. The gradient in the image, hereinafter referred to as the image gradient, can be determined using a gradient detection technique, for example using a sobel operator. The sobel operator can be used to compute an approximate value for the image gradient. The gradient map represents value of gray level gradient at a pixel location. In one example, the image gradient represents magnitude and direction of change in gray level values.

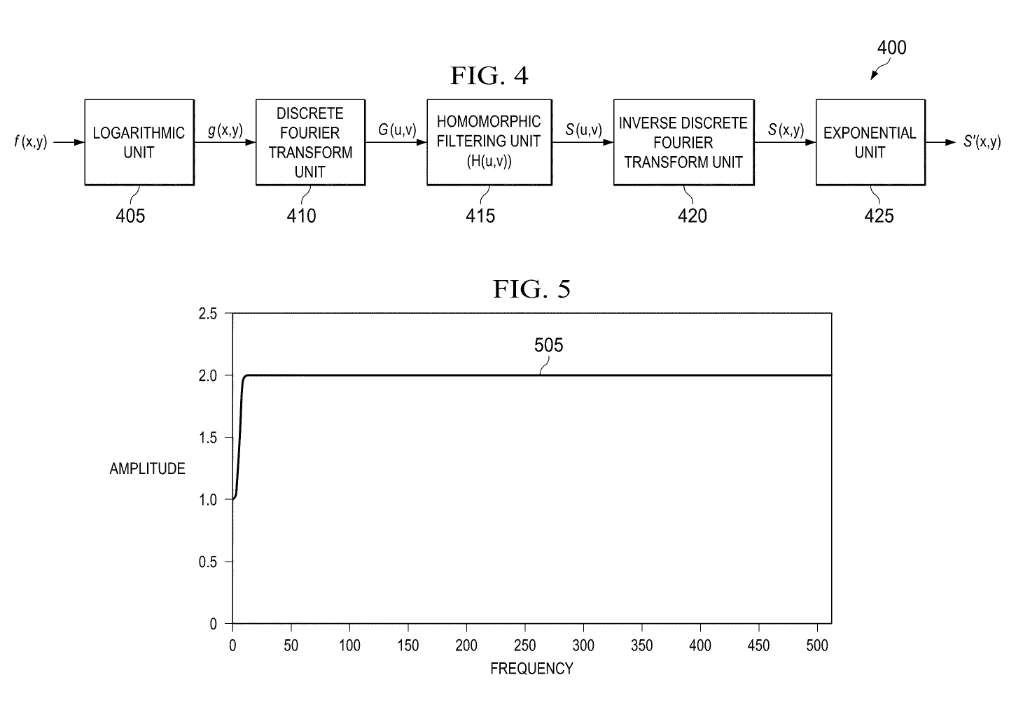

At step 225, the image is filtered based on a homomorphic filtering technique to yield a homomorphic filtered image. The homomorphic filtering technique includes mapping spatial domain representation of the image to another domain, for example a frequency domain and performing filtering in the frequency domain. The homomorphic filtering technique enhances contrast of the image. The homomorphic filtering technique is further explained in conjunction with FIG. 4.

At step 230, breast region is extracted from the image based on the smoothened image and the gradient map using fuzzy rule based pixel classification to yield a binary image. The binary image can be defined as an image whose pixels values are represented by binary values.

The fuzzy rule based pixel classification includes checking a rule base. The rule base is based on the average gray level value and the image gradient and is used to determine pixels representing the breast region and pixels representing background region.

The checking of the rule base includes receiving the smoothened image and the gradient image. The fuzzy rule based pixel classification makes use of linguistic variable graphs to demarcate the breast region from the background region. The linguistic variable graphs are predefined based on experimentation. A first linguistic variable (A) graph corresponds to the average gray level value and related certainty of it being LOW or HIGH and a second linguistic variable (G) graph corresponds to the image gradient and related certainty of it being LOW or HIGH. For a first pixel, the certainty of the first pixel having a LOW value or a HIGH value in the first linguistic graph is determined. Similarly, the certainty for other pixels in the first linguistic graph is determined. Likewise, the certainty of the first pixel and other pixels having a LOW value or a HIGH value in the second linguistic graph is determined. Based on the LOW value and the HIGH value in the graphs, the image is classified as the background (Bg) region or the breast region (Br) using the following rules:

If the average gray level value (A) of the pixel is LOW “AND” the gradient value (G) of the pixel is LOW then the pixel belongs to the background region (Bg). The “AND” operator represents minimum of two values.

If the average gray level value (A) of the pixel is LOW “AND” the gradient value (G) of the pixel is HIGH or if the average gray level value (A) is HIGH, then the pixel belongs to the breast region (Br).

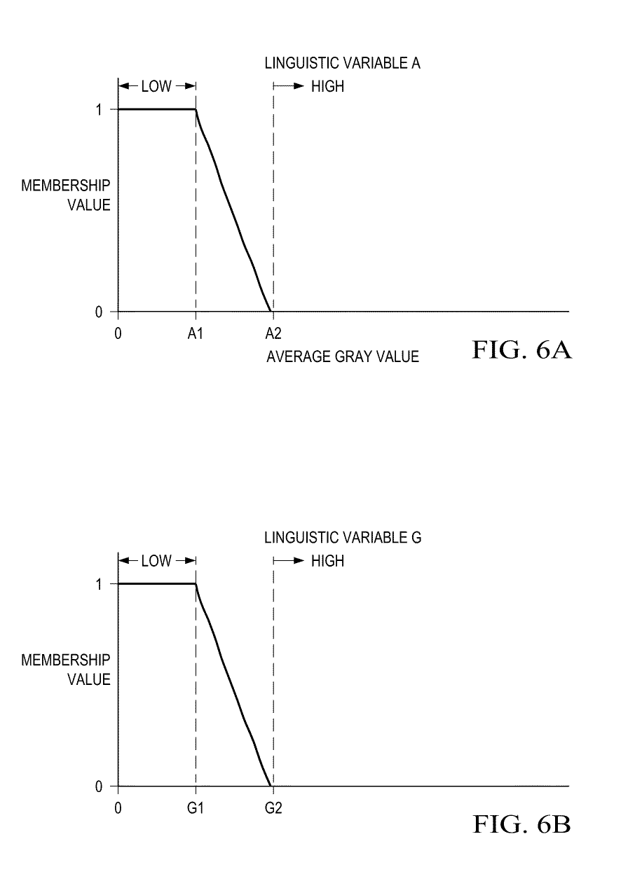

The first linguistic graph and the second linguistic graph are further explained in conjunction with FIG. 6A and FIG. 6B.

At step 235, the binary image is filtered to remove noise. The binary image can be filtered using morphological filtering techniques, for example morphological opening-closing with a binary mask and a connected component labeling technique to yield a filtered image. In one example, the morphological opening-closing with a binary mask of radius N pixels can be defined as a technique to fill holes in the breast region and the background region. In another example, the connected component labeling technique can be defined as a technique to detect and connect regions filled with holes in the image.

At step 240, boundary of the breast region is extracted. In one example, the boundary of the breast region is extracted using morphological boundary extraction techniques.

In one embodiment, the morphological boundary extraction technique can be performed using two steps, for example an erosion step followed by a subtraction step. In another embodiment, the morphological boundary extraction technique can be performed using a dilation step followed by a subtraction step. Erosion, dilation, and subtraction are morphological operations. In a morphological operation, value of each pixel in an output image is based on a comparison of corresponding pixel in an input image with neighboring pixels. By choosing size and shape of neighborhood, an appropriate morphological operation can be performed that is sensitive to specific shapes in the input image. In one example, the morphological operation of dilation adds pixels to object boundaries, while the morphological operation of erosion removes pixels on object boundaries. In another example, the morphological operation of subtraction takes two images as input and produces as output a third image whose pixel values are those of a first image minus corresponding pixel values from a second image.

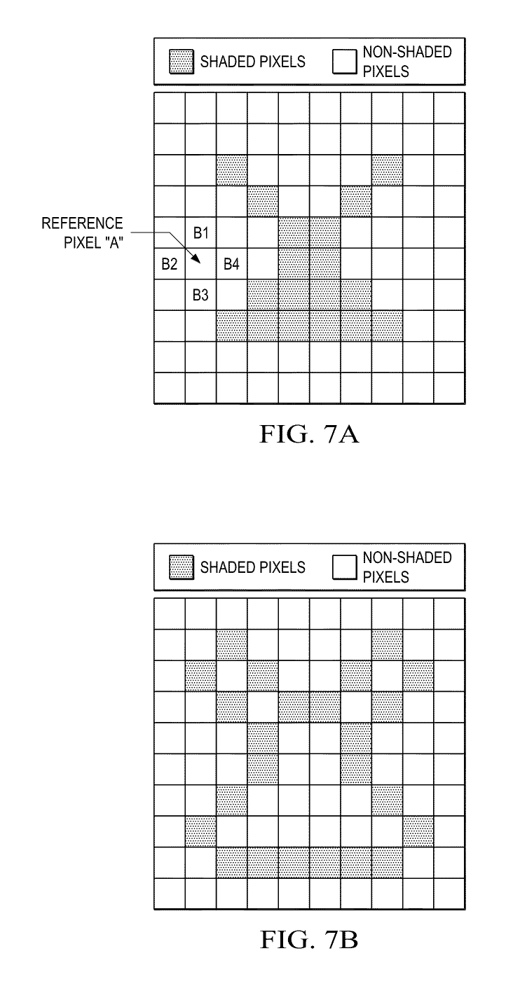

In yet another embodiment, the morphological boundary extraction technique can include one step of erosion, dilation or subtraction. The boundary extracted using the morphological boundary extraction technique is an approximate boundary of the breast region and is further processed to determine accurate boundary of the breast region. The morphological boundary extraction technique is further explained in conjunction with FIG. 7A and FIG. 7B.

At step 245, the skinline is detected based on extracted boundary of the breast region. The skinline is detected based on active contour technique. The active contour technique uses the smoothened image, the gradient map, and the homomorphic filtered image as inputs to determine the skinline. The active contour technique is an energy minimizing technique that is used to detect image contours, for example lines and edges in the image. In one example, the active contour technique uses a greedy snake algorithm to detect the image contours. The greedy snake algorithm tracks the image contours and matches them to determine the accurate boundary of the breast region, thereby determining accurate skinline. The active contour technique at any instant of time tries to minimize an energy function and hence is termed as an active technique. Further, the image contours slither while minimizing the energy function and hence the contours are termed as snakes. The active contour technique is further described in “Snakes: Active contour models” Kass, M., Witkin, A., Terzopoulos, D., and W. H. Wolberg, International Journal of Computer Vision, pp 321-331, 198, which is incorporated herein by reference in its entirety.

The image after detecting the skinline can be classified into the breast region and the background region.

At step 250, the skinline can be marked and further the image with marked skinline and breast map can be processed for breast lesion detection and diagnosis.

It is noted that one or more of these steps can be performed in parallel, for example step 225 can be performed in parallel with step 215 or step 220.

Referring to FIG. 2B now, various steps involved in determining skinline are illustrated. It is noted that FIG. 2B represents a generic flowchart for determining the skinline.

At step 252, a digital mammogram image is received. The digital mammogram image, hereinafter referred to as the image can be received from an x-ray detector, for example the x-ray detector 115.

At step 254, the image is de-noised to remove speckle noise and salt-pepper noise.

At step 256, an approximate skinline is extracted. The approximate skinline can be extracted using morphological boundary extraction techniques.

At step 258, contrast of the image is enhanced. It is noted that step 258 can be performed in parallel with step 256.

At step 260, an accurate skinline is detected. The accurate skinline can be detected using an active contour technique.

At step 262, a marked breast skinline and a breast map is generated. The breast map can be defined as a map constituting features of the breast, including details of suspicious lesions. In some embodiments, the breast map can also be referred to as a breast mask. The skinline can be marked and further the image with marked skinline and the breast map can be processed for breast lesion detection and diagnosis. The breast lesion detection and diagnosis using the marked skinline is further explained in FIG. 2C.

Referring to FIG. 2C now, breast lesion detection and diagnosis can be done using various techniques. One exemplary technique includes the following steps:

At step 264, a digital mammogram image is received.

At step 266, skinline is detected in the digital mammogram image. Detection of the skinline in the digital mammogram image is performed based on the following steps. The digital mammogram image is first de-noised. The digital mammogram image is then smoothened to yield a smoothened image. Further, gradient in the digital mammogram image is determined to yield a gradient map. The digital mammogram image is filtered based on a homomorphic filtering technique to yield a homomorphic filtered image. The breast region is extracted from the digital mammogram image based on the smoothened image and the gradient map using fuzzy rule based pixel classification to yield a binary image. The binary image is filtered to remove noise and to yield a filtered image. The binary image can be filtered using morphological filtering techniques. Further, boundary of the breast region is extracted. In one example, the boundary of the breast region is extracted using morphological boundary extraction techniques. The skinline is then detected using an active contour technique.

At step 268, a breast mask is generated. The breast mask includes a marked skinline. The breast mask is further used to define regions of interest for the breast lesion detection and diagnosis by image analysis and region of interest (ROI) based compression of the digital mammogram image.

At step 270, the regions of interest defined by the breast mask is further processed for the breast lesion detection and diagnosis. The image is analyzed and region of interest based compression algorithms are implemented. Further, analyzed image is used for the breast lesion detection and diagnosis.

At step 272, an abnormality marked image is generated. The abnormality marked image includes region in the breast where suspected lesions have been found.

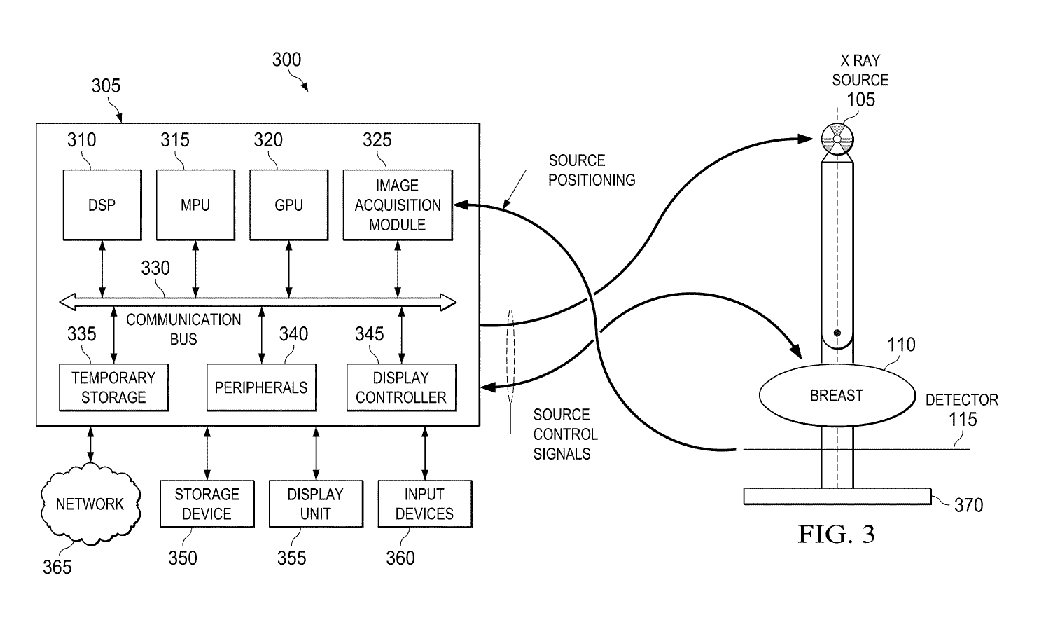

FIG. 3 illustrates a block diagram of a system 300 for determining skinline in an image of a breast 110. The system 300 includes an image processing unit (IPU) 305. The IPU 305 includes one or more peripherals 340, for example a communication peripheral, in electronic communication with other devices, for example a storage device 350, a display unit 355, and one or more input devices 360. Examples of an input device include, but are not limited to a keyboard, a mouse, a touch screen through which a user can provide an input. Examples of the communication peripheral include ports and sockets. The storage device 350 stores the image. The display unit 355 is used to display skinline of the breast 110 and an abnormalities marked image. The IPU 305 can also be in electronic communication with a network 365 to transmit and receive data including images. The peripherals 340 can also be coupled to the IPU 305 through a switched central resource, for example a communication bus 330. The communication bus 330 can be a group of wires or a hardwire used for switching data between the peripherals or between any component in the IPU 305. The IPU 305 can also be coupled to other devices for example at least one of the storage device 350 and the display 355 through the communication bus 330. The IPU 305 can also include a temporary storage 335 and a display controller 345. The temporary storage 335 stores temporary information. An example of the temporary storage 335 is a random access memory.

The breast 110 is placed between an x-ray source 105 and a detector 115. In one example, the x-ray source 105 can be a linear accelerator that generates x-rays by accelerating electrons. In one example, the detector 115 can be an x-ray detector and can detect x-rays. Examples of the detector 115 include, but are not limited to photographic plate, a Geiger counter, a scintillator, and a semiconductor detector. The image of the breast 110 is captured by the detector 115. In one embodiment, an imaging setup 370 is required to position the x-ray source 105 and the detector 115.

An image acquisition module 325 electronically receives the image of the breast 110 from an image detector, for example the detector 115. In one example, the image acquisition module 325 can be a video processing subsystem (VPSS). The IPU 305 includes a digital signal processor (DSP) 310, coupled to the communication bus 330 that receives the image of the breast 110 and processes the image. The IPU 305 includes a micro-processor unit (MPU) 315 and a graphics processing unit (GPU) 320 that processes the image in conjunction with the DSP 310. The GPU 320 can process image graphics. The MPU 315 controls operation of components in the IPU 305 and includes instructions to perform processing of the image on the DSP 310.

The storage device 350 and the display 355 can be used for outputting result of processing. In some embodiments, the DSP 330 also processes a skinline detected breast image and is used for breast lesion detection and diagnosis. The DSP 330 also generates the abnormality marked image, which can then be displayed, transmitted or stored, and observed. The abnormalities marked image is displayed on the display 355 using a display controller 345.

FIG. 4 illustrates a block diagram for performing homomorphic filtering technique. A system 400 for performing the homomorphic filtering technique includes a logarithmic unit 405 coupled to a discrete Fourier transform (DFT) unit 410. The DFT unit 410 is coupled to a homomorphic filtering unit 415. The homomorphic filtering unit 415 is coupled to an inverse Fourier transform (IDFT) unit 420. The IDFT unit 420 is coupled to an exponential unit 425.

The logarithmic unit 405 receives an input x-ray image that can be represented as a function f(x, y). The input x-ray image f(x, y) can be expressed as a product of incident radiation (i(x, y)) and attenuation offered by tissue along different paths taken by the x-ray through the tissue (t(x, y)) as given below:

f(x, y)=i(x, y)×t(x, y)

Output of the logarithmic unit 405 can be expressed as g(x, y) and can be calculated as given below:

g(x, y)=ln f(x, y)

g(x, y)=ln i(x, y)+ln t(x, y)

The DFT unit 410 receives the output g(x, y) and computes Fourier transform of g(x, y). In one example, the Fourier transform can be defined as a mathematical operation that transforms a signal in spatial domain to a signal in frequency domain. The Fourier transform of g(x, y) can be calculated as given below:

F{g(x, y)}=F{ln i(x, y)}+F{ln t(x, y)}

Or

G(u, v)=I(u, v)+T(u, v)

Where I(u, v) is the Fourier transform of ln i(x, y) and T(u, v) is the Fourier transform of ln t(x, y).

The homomorphic filtering unit 415 applies a filter represented by response function H(u, v) on G(u, v) to output S(u, v). The output S(u, v) can be calculated as given below:

S(u, v)=H(u, v)·G(u, v)

S(u, v)=H(u, v)·I(u, v)+H(u, v)·T(u, v)

The IDFT unit 420 calculates the inverse Fourier transform of S(u, v) to output S(x, y). The output S(x, y) is in spatial domain and can be calculated as given below:

F⁻¹{S(u, v)}=S(x, y)=i′(x, y)+t′(x, y)

The exponential unit 425 calculates exponential of S(x, y) to output S′(x, y). The output S′(x, y) gives an enhanced image and can be calculated as given below:

exp(S(x, y))=exp[i′(x, y)]×exp[t′(x, y)]

S′(x, y)=i″(x, y)×t″(x, y)

Now, i″(x, y) and t″(x, y) are illumination and attenuation components of the enhanced image. An illumination component tends to vary gradually across the image. An attenuation component tends to vary rapidly across the image. It is noted that there is a step change in skinline-air interface in the enhanced image. Therefore, by applying a frequency domain filter like the homomorphic filtering unit 415 having a frequency response as shown in FIG. 5, improves detail in breast region and near the skinline.

FIG. 5 illustrates a frequency response of a homomorphic filter, for example the homomorphic filtering unit 415. X-axis represents frequency and y-axis represents amplitude. A waveform 505 indicates the frequency response.

FIG. 6A illustrates a first linguistic graph. The first linguistic graph corresponds to a linguistic variable A that represents average gray level value of a pixel and certainty of it being LOW or HIGH. In one example, the linguistic variable A can have a membership value of 0 to 1 towards a set of pixels having the average gray level value LOW or HIGH. FIG. 6B illustrates a second linguistic graph. The second linguistic graph includes a linguistic variable G that represents image gradient at a pixel location and certainty of it being LOW or HIGH. In one example, the pixel can have a membership value of 0 to 1 towards a set of pixels having image gradient value LOW or HIGH. The linguistic variable A and the linguistic variable G can be further have values, for example from 0 to 255. Referring to FIG. 6A now, the linguistic variable A is considered a LOW value with 100 percent certainty if its value is less than a threshold A1. The linguistic variable A is considered a HIGH value with 100 percent certainty if its value is greater than a threshold A2. Likewise, in FIG. 6B the linguistic variable G is considered a LOW value with 100 percent certainty if its value is less than a threshold G1. Further, the linguistic variable G is considered a HIGH value with 100 percent certainty if its value is greater than a threshold G2. A threshold can be defined as a value that classifies the average gray level value or the image gradient as LOW or HIGH. In one embodiment, thresholds can be selected based on accuracy required for classifying the image as background region or breast region.

In some embodiments, A can have a value between the thresholds A1 and A2. G can also have a value between the thresholds G1 and G2.

In one example, let A1=1 and A2=2

If A=0.7, then A<A1 and is considered LOW with 100 percent certainty

If A=2.7, then A>A2 and is considered HIGH with 100 percent certainty

If A=1.3, then A is between A1 and A2. A has 0.7 certainty of being LOW or in other words 0.3 certainty of being HIGH.

In another example, let G1=2 and G2=3

If G=0.7, then G<G1 and is considered LOW with 100 percent certainty

If G=3.7, then G>G2 and is considered HIGH with 100 percent certainty

If G=2.3, then G is between G1 and G2. G has 0.7 certainty of being LOW or in other words 0.3 certainty of being HIGH.

In yet another example, let G1=2 and G2=3

If G=0.7, then G<G1 and is considered LOW with 100 percent certainty

If G=3.7, then G>G2 and is considered HIGH with 100 percent certainty

G=2.7, then G is between G1 and G2. G has 0.3 certainty of being LOW or in other words 0.7 of being HIGH.

A rule base can be created by defining a pixel as a pixel representing the background region if the average gray level value of the pixel is a first predefined value (LOW) and the gradient value of the pixel is the first predefined value (LOW). It is noted that the background region is a low intensity homogeneous region and hence the average gray level value of the pixel is LOW and the gradient value of the pixel is LOW. The pixels representing the background region can be defined based on the following rule:

If the average gray level value (A) of the pixel is LOW “AND” the gradient value (G) of the pixel is LOW then the pixel belongs to the background region (Bg). The “AND” operator represents minimum of two values.

The rule base can be created by defining the pixel as a pixel representing the breast region if the average gray level value of the pixel is the first predefined value (LOW) and the gradient value of the pixel is a second predefined value (HIGH) or by defining the pixel as a pixel representing the breast region if the average gray level value of the pixel is the second predefined value (HIGH). It is noted that the breast region is a high intensity non homogeneous region and hence the average gray level value of the pixel is HIGH and the gradient value of the pixel is HIGH. The pixels representing the breast region can be defined based on the following rule:

If the average gray level value (A) of the pixel is LOW “AND” the gradient value (G) of the pixel is HIGH or if the average gray level value (A) is HIGH, then the pixel belongs to the breast region (Br).

The rule base can be further explained with the following examples:

If A is 0.7 (LOW) and G is 0.3 (HIGH) then the pixel value is minimum of 0.7 and 0.3, that is 0.3 (HIGH). Hence, the pixel belongs to the breast region.

### Example 2

If A is 0.7 (LOW) and G is 0.6 (LOW) then the pixel value is minimum of 0.7 and 0.6, that is 0.6 (LOW). Hence, the pixel belongs to the background region.

### Example 3

If A is 0.3 (High) then the pixel belongs to the breast region.

FIG. 7A and FIG. 7B illustrates a morphological extraction technique. A boundary of a breast region is extracted using the morphological boundary extraction technique. In one embodiment, the morphological boundary extraction technique can be performed using two steps, for example an erosion step followed by a subtraction step. In another embodiment, the morphological boundary extraction technique can be performed using a dilation step followed by a subtraction step. In another embodiment, the morphological boundary extraction technique can include one step of erosion, dilation or subtraction. For every pixel p(i, j) belonging to a binary image, the boundary of the breast region is represented as b(i, j). The boundary of the breast region can be extracted using the equation given below:

b(i, j)=p(i, j)⊕( [symbol] (q)∀q∈ N₄(p(i, j)))

Where ⊕ represents a logical exclusive OR operation, and [symbol] (•) represents logical AND operation, N₄(•) represents a 4-neighbourhood around the pixel in the argument.

Referring to FIG. 7A now, shaded pixels have value 1 and non-shaded pixels have value 0. Let A be a reference pixel. Let B1, B2, B3, and B4 be neighboring pixels of the reference pixel A. A logical AND operation is performed between the reference pixel A and the neighboring pixels. The logical AND operation results in an output value 0. A logical exclusive OR operation is performed between the output value 0 and the reference pixel A to output a value 1. Since the output value is 1, the reference pixel is considered as a boundary. Similarly, the logical AND operation and the exclusive OR operation is carried out for other pixels to extract the boundary of the breast region. The extracted boundary of the breast region is shown in FIG. 7B.

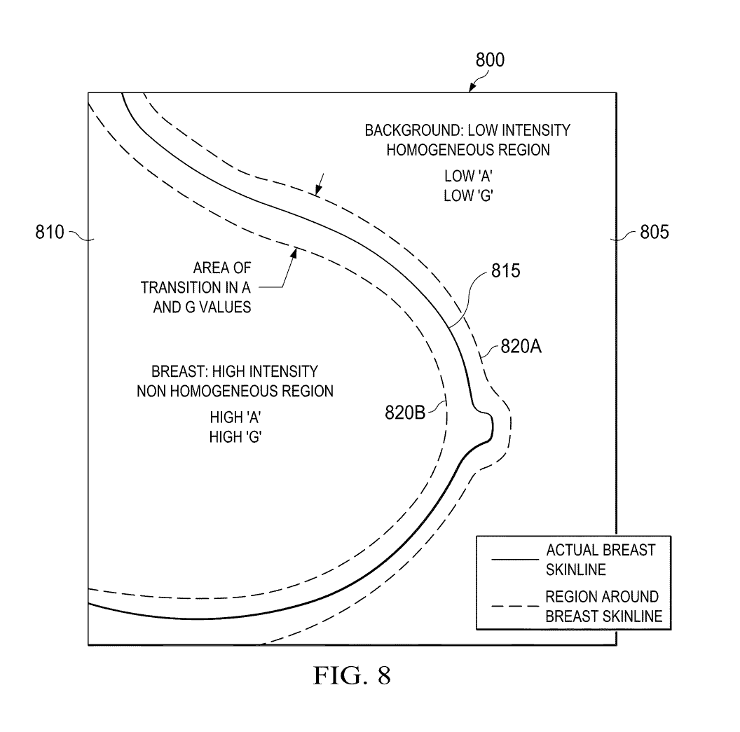

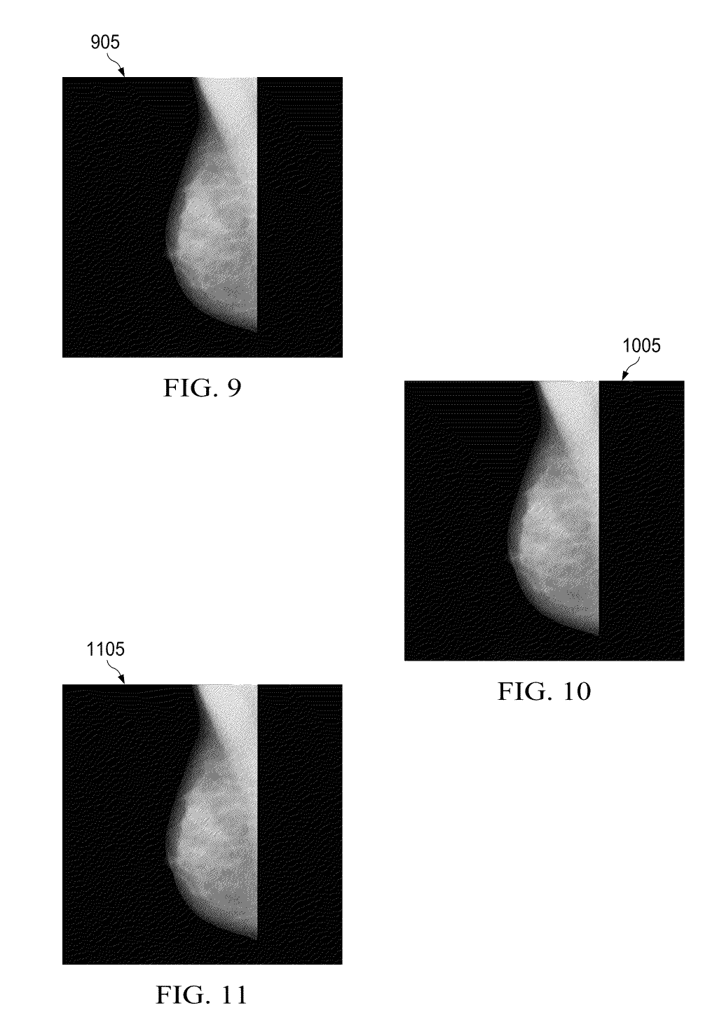

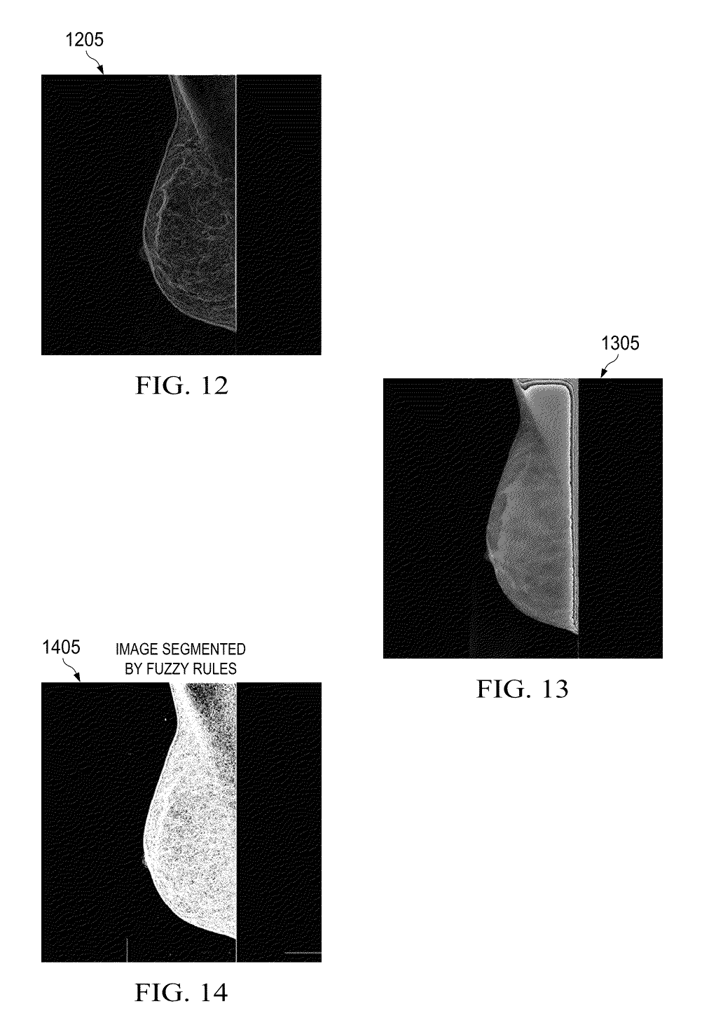

Referring to FIG. 8 now, a breast image 800 includes a background region 805 which is a low intensity homogeneous region and a breast region 810 which is a high intensity non homogeneous region. The background region 805 includes pixels having LOW average gray level (A) values and LOW gradient (G) values. The breast region 810 includes pixels having HIGH average gray level values and HIGH gradient values. Further, the breast image 800, hereinafter referred to as the image 800 includes a transition region (represented as a region between a curve 820A and a curve 820B) of the average gray level and the gradient values across skinline 815 in the image 800. The image 800 is processed to detect the skinline 815. The image 800 is received from an image source, for example an x-ray detector and further de-noised to remove noises including speckle noise and salt-pepper noise. A received image 905 is shown in FIG. 9 and a de-noised image 1005 is shown in FIG. 10. The image 1005 is then smoothened to yield a smoothened image 1105. The smoothened image 1105 is shown in FIG. 11. Further, gradient in the image 800 is determined to yield a gradient map 1205. The gradient map 1205 is shown in FIG. 12. The image 800 is filtered based on a homomorphic filtering technique to yield a homomorphic filtered image 1305. The homomorphic filtered image 1305 is shown in FIG. 13.

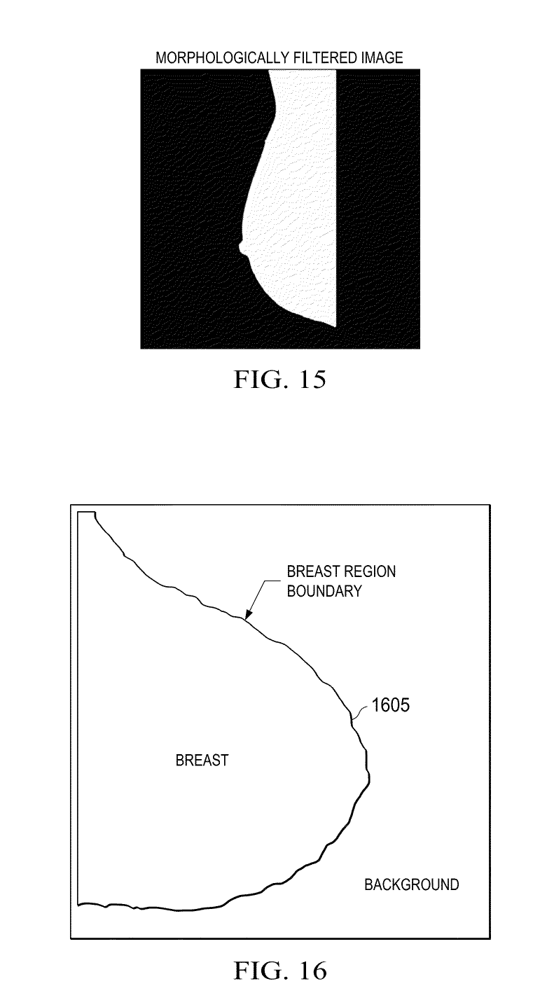

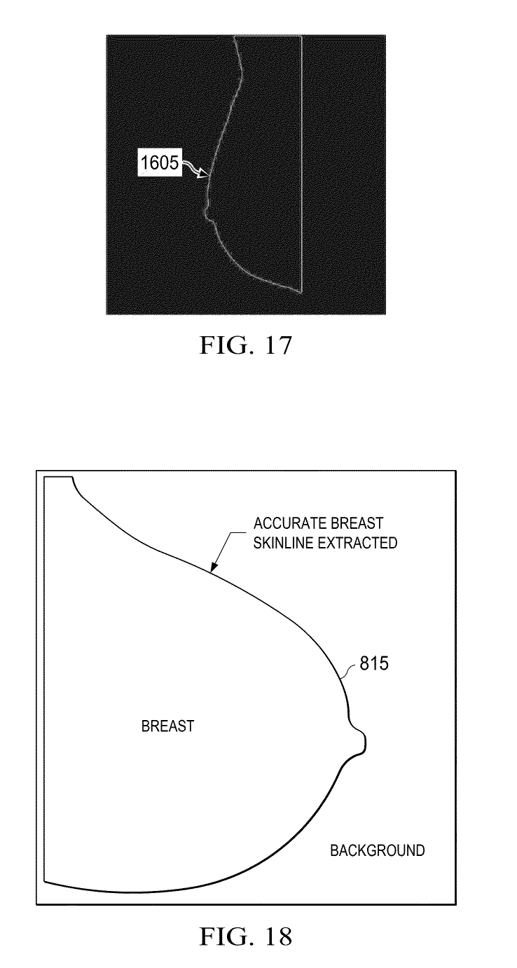

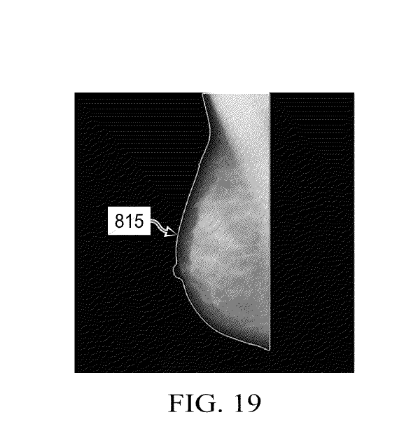

The breast region 810 is extracted based on the smoothened image 1105 and the gradient map 1205 using a fuzzy rule based pixel classification to yield a binary image 1405. The binary image 1405 is shown in FIG. 14. The binary image 1405 is filtered to remove noise. The binary image 1405 can be filtered using morphological filtering techniques. The binary image 1405 after removing the noise is shown in FIG. 15. Further, boundary of the breast region 1605 is extracted. In one example, the boundary of the breast region 1605 is extracted using morphological boundary extraction techniques. It is noted that the boundary of the breast region 1605 after morphological boundary extraction is inaccurate and uneven in shape. The image after extraction of the boundary of the breast region 1605 is shown in FIG. 16 and FIG. 17. The skinline 815 is then detected using an active contour technique. The image after detection of the skinline 815 is shown in FIG. 18 and FIG. 19.

The skinline 815 that is detected using the techniques in disclosure is accurate and easy to visualize. The skinline 815 can act as a registration aid in comparing images of left and right breasts or in comparing views of same breast taken at different times. Further, the skinline 815 can be used to define region of interest for abnormality detection and image compression. The skinline 815 detected can reduce computational requirements for consecutive image analysis stages for breast lesion detection and diagnosis.

In the foregoing discussion, the term “coupled or connected” refers to either a direct electrical connection or mechanical connection between the devices connected or an indirect connection through intermediary devices.

The foregoing description sets forth numerous specific details to convey a thorough understanding of embodiments of the disclosure. However, it will be apparent to one skilled in the art that embodiments of the disclosure may be practiced without these specific details. Some well-known features are not described in detail in order to avoid obscuring the disclosure. Other variations and embodiments are possible in light of above teachings, and it is thus intended that the scope of disclosure not be limited by this Detailed Description, but only by the Claims.

What is claimed is:

1. A method for determining skinline in a digital mammogram image, the method comprising:
smoothening the digital mammogram image to yield a smoothened image;
determining gradient in the digital mammogram image to yield a gradient map;
extracting breast region from the digital mammogram image based on the smoothened image and the gradient map using fuzzy rule based pixel classification to yield a binary image;
filtering the binary image to remove noise and to yield a filtered image;
extracting boundary of the breast region in the filtered image; and
detecting the skinline based on the boundary of the breast region.

2. The method as claimed in claim 1, wherein determining the skinline in the digital mammogram image comprises
determining the skinline in the digital mammogram image by an image processing unit (IPU), the IPU being electronically coupled to a source of the digital mammogram image.

3. The method as claimed in claim 1 and further comprising
de-noising the digital mammogram image.

4. The method as claimed in claim 3, wherein de-noising the digital mammogram image comprises
de-noising speckle noise and salt-pepper noise associated with the digital mammogram image based on a median filter.

5. The method as claimed in claim 1, wherein
the smoothened image represents average gray level value of pixels surrounding a pixel, and
the gradient map represents gradient value at a pixel location.

6. The method as claimed in claim 5, wherein extracting the breast region comprises:
creating a rule base based on the average gray level value and the gradient value in the digital mammogram image; and
determining pixels representing the breast region and pixels representing background region based on the rule base.

7. The method as claimed in claim 6, wherein creating the rule base comprises
defining a pixel as a pixel representing the background region if the average gray level value of the pixel is equal to a first predefined value and the gradient value of the pixel is equal to the first predefined value.

8. The method as claimed in claim 7, wherein creating the rule base comprises at least one of:
defining the pixel as a pixel representing the breast region if the average gray level value of the pixel is equal to the first predefined value and the gradient value of the pixel is equal to a second predefined value; and
defining the pixel as a pixel representing the breast region if the average gray level value of the pixel is equal to the second predefined value.

9. The method as claimed in claim 1, wherein filtering comprises
filtering the breast region based on a morphological filtering technique.

10. The method as claimed in claim 1 and further comprising
filtering the digital mammogram image based on a homomorphic filtering technique to yield a homomorphic filtered image.

11. The method as claimed in claim 10, wherein detecting the skinline comprises
detecting the skinline based on the smoothened image, the gradient map, and the homomorphic filtered image.

12. The method as claimed in claim 11, wherein detecting the skinline comprises
detecting the skinline based on an active contour technique.

13. The method as claimed in claim 12 and further comprising
classifying the digital mammogram image into the breast region and background region.

14. A method for determining skinline in a digital mammogram image by an image processing unit, the method comprising:
smoothening the digital mammogram image to yield a smoothened image;
determining gradient in the digital mammogram image to yield a gradient map;
extracting breast region from the digital mammogram image based on the smoothened image and the gradient map using fuzzy rule based pixel classification to yield a binary image;
filtering the binary image to remove noise and to yield a filtered image;
extracting boundary of the breast region in the filtered image;
filtering the digital mammogram image based on a homomorphic filtering technique to yield a homomorphic filtered image; and
detecting the skinline based on the smoothened image, the gradient map, and the homomorphic filtered image.

15. The method as claimed in claim 14 and further comprising
de-noising the digital mammogram image.

16. The method as claimed in claim 14 and further comprising
classifying the digital mammogram image into the breast region and background region.

17. An image processing unit for determining skinline in a digital mammogram image, the image processing unit (IPU) comprising:
an image acquisition unit that electronically receives the digital mammogram image; and
a digital signal processor (DSP) responsive to the digital mammogram image to
de-noise the digital mammogram image;
smoothen the digital mammogram image to yield a smoothened image;
determine gradient in the digital mammogram image to yield a gradient map;
extract breast region from the digital mammogram image based on the smoothened image and the gradient map using fuzzy rule based pixel classification to yield a binary image;
filter the binary image to remove noise and to yield a filtered image;
extract boundary of the breast region in the filtered image;
filter the digital mammogram image based on a homomorphic filtering technique to yield a homomorphic filtered image; and
detect the skinline based on at least one of the smoothened image, the gradient map, and the homomorphic filtered image.

18. The IPU as claimed in claim 17, wherein the IPU comprises:
a graphics processing unit that processes image graphics;
a micro-processor unit that controls execution of instructions to perform processing of the digital mammogram image;
a temporary storage that stores temporary information;
one or more peripherals that communicates with other devices; and
a display controller that enables a display unit to display skinline of the breast and an abnormalities marked image.

19. The IPU as claimed in claim 17, wherein the IPU is electronically coupled to at least one of:
an x-ray source that generates x-rays;
an image detector that detects the x-rays and to generate the digital mammogram image;
a display unit that display skinline of the breast and an abnormalities marked image;
a storage device that stores the digital mammogram image; and
a network that enables reception and transmission.
